(19) United States
(12) Patent Application Publication
(10) Pub. No.: US 2013/0326389 A1
(43) Pub. Date: Dec. 5, 2013

(54) KEY INPUT ERROR REDUCTION

(71) Applicant: Seungil Kim, Seoul (KR)

(72) Inventor: Seungil Kim, Seoul (KR)

(73) Assignee: EMPIRE TECHNOLOGY DEVELOPMENT LLC, Wilmington, DE (US)

(21) Appl. No.: 13/132,224

(22) PCT Filed: Feb. 24, 2011
(86) PCT No.: PCT/US11/25993

§ 371 Date: Jun. 1, 2011

(51) Int. Cl. G06F 3/0488

(52) U.S. Cl. CPC G06F 3/04886
USPC 715/773

(57) ABSTRACT

Technologies are generally described for devices, methods, and programs for reducing key input errors. An example device includes a detector to determine characteristics of a detected input and an arbiter to reject the detected input that has characteristics of an input error.

### BACKGROUND

Touchscreen technology in computing devices is becoming a driving force in the enterprise and consumer marketplaces. Thus, touchscreen displays are being made to accommodate multiple form factors, i.e., size and mobility, desired in the present day markets for computing devices, including, e.g., laptop computers, tablet/slate devices, personal digital assistants (PDAs), global positioning system (GPS) devices, mobile phones, and smart phones. However, while touchscreen technology represents advancement in software and hardware input technology, there is no accompanying advancement in the human component for input technology. This is also generally the case for other input devices such as the standard keypads and keyboards.

### SUMMARY

In one example, a device includes a detector to determine characteristics of a detected touch input and an arbiter to reject the detected touch input that has characteristics of a key input error.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

The foregoing and other features of this disclosure will become more fully apparent from the following description and appended claims, taken in conjunction with the accompanying drawings. Understanding that these drawings depict only several embodiments in accordance with the disclosure and are, therefore, not to be considered limiting of its scope, the disclosure will be described with additional specificity and detail through use of the accompanying drawings, in which:

FIG. 1 shows an overview of an example processing flow for key input error reduction;

FIG. 2 shows an overview of an example touchscreen device upon which at least one embodiment of key input error reduction may be implemented;

FIG. 3 shows an overview of an example processing device and corresponding input device upon which at least one other embodiment of key input error reduction may be implemented;

FIG. 4 shows an example processing flow for key input error reduction;

FIG. 5 shows another example processing flow for key input error reduction; and

FIG. 6 shows a block diagram illustrating an example computing device by which various embodiments of key input error reduction may be implemented.

### DETAILED DESCRIPTION

In the following detailed description, reference is made to the accompanying drawings, which form a part of the description. In the drawings, similar symbols typically identify similar components, unless context dictates otherwise. Furthermore, unless otherwise noted, the description of each successive drawing may reference features from one or more of the previous drawings to provide clearer context and a more substantive explanation of the current example embodiment. Still, the example embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein.

In the following description, the terms “key input” and “touch input” may be used interchangeably. Both a “key input” and a “touch input” may refer to physical contact by a user or a passive device, i.e., stylus, to a virtual onscreen keyboard, a standard keyboard, or non-standard keyboard, e.g., a foldable keyboard, a projected or laser keyboard, or an optical keyboard. Further still, “touch input,” when explicitly stated, may also refer to physical contact by a user or a passive device to a touchscreen, i.e., an electronic visual display.

In addition, a result of the physical contact for a “key input” or “touch input” may refer to an activation of an appropriate function or feature corresponding to a key on a virtual onscreen keyboard for an application or program hosted, or running, on a corresponding computing device, a standard keyboard, or a non-standard keyboard for an application or program. Typically, when referring to a singular “key input” or “touch input” on a virtual onscreen keyboard, a standard keyboard, or a non-standard keyboard, the activated function or feature is an alpha-numeric character. Exceptions, including “special functions,” are described further herein.

Even further, unless required for the description of a particular embodiment, reference to a “keyboard” or “keyboards” may refer to any one or more of the aforementioned virtual onscreen keyboard, standard keyboard, or non-standard keyboard.

Furthermore, the following description includes references to a “key input” and/or “touch input” being made “in combination,” i.e., “simultaneously” or “simultaneous” with another such “key input” and/or “touch input.” Both “simultaneously” and “simultaneous” refer to a detection of such combination of “key inputs” and/or “touch inputs” at the same, or substantially same, time, regardless of whether one of the detected combinations of inputs commences before the other, so long as the detection thereof is for a measurable amount of time.

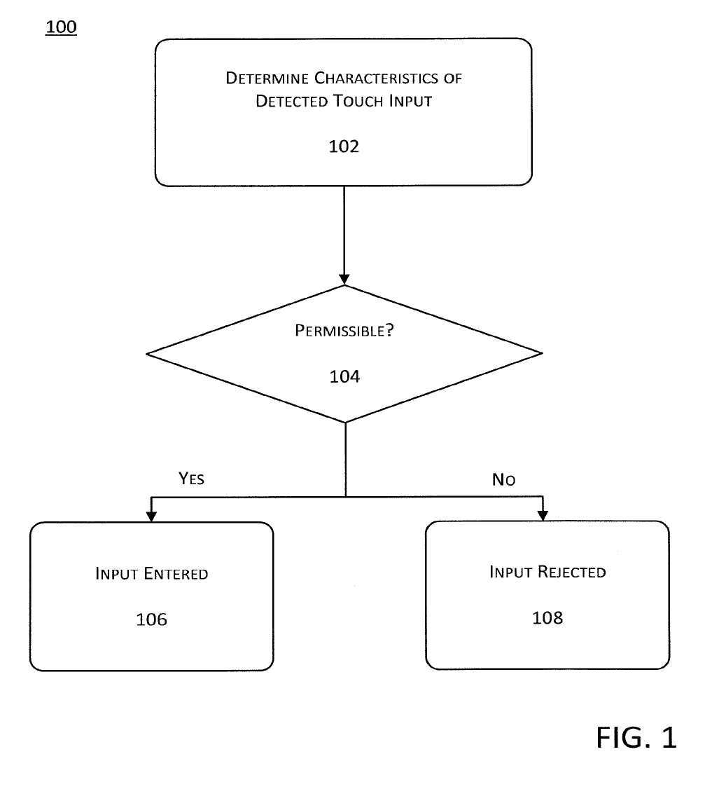

FIG. 1 shows an overview of an example processing flow 100 for key input error reduction. An example processing flow may include one or more operations, actions, or functions as illustrated by one or more of blocks 102, 104, 106 and/or 108. Although illustrated as discrete blocks, various blocks may be divided into additional blocks, combined into fewer blocks, or eliminated, depending on the desired implementation. Processing may begin at block 102.

In accordance with a first example embodiment of key input error reduction, processing flow 100 is described in the context of reducing key input errors resulting from an inadvertent or erroneous touch input on at least one of a virtual onscreen keyboard, a touch input display, a standard keyboard, or a non-standard keyboard.

In accordance with a second example embodiment of key input error reduction, processing flow 100 is described in the context of reducing key input errors resulting from extended touch inputs on at least one of a virtual onscreen keyboard, a touch input display, a standard keyboard, or a non-standard keyboard.

Block 102 (Determine Characteristics of Detected Touch Input), in either of the first or second example embodiments, may include detecting a touch input to the keyboard either singularly or in combination with another touch input to the keyboard or with a touch input to the touch input display, and determining an appropriate function or feature to be activated for the detected touch input. Processing may continue from block 102 to decision block 104.

Decision block 104 (Permissible?), in at least the first example embodiment, may include determining whether the touch input detected at block 102 is permissible, i.e., satisfies one or more predetermined criterion for an acceptable function or feature for an application, program, or operating system that is hosted, or otherwise running, on a device to which the keyboard corresponds. Non-limiting examples of a detected touch input that is permissible include a singular alpha-numeric key; a special function key in combination, i.e., simultaneous, with an alpha-numeric key; a customized special function combination, i.e., simultaneous, of alpha-numeric keys or special function keys, e.g., “control-alt-delete.” Processing may continue from decision block 104 to either block 106 or 108.

If the determination at decision block 104 is “yes,” the detected touch input may be entered at block 106 (Input Entered) to activate the appropriate function or feature.

If the determination at decision block 104 is “no,” the detected touch input may be rejected at block 108 (Input Rejected).

Decision block 104 (Permissible?), in at least the second example embodiment, may include determining whether an end or termination to the touch input has been detected before a predetermined threshold amount of time has elapsed.

In this example embodiment, if the determination at decision block 104 is “yes,” assuming the detected touch input is otherwise valid, e.g., an acceptable combination of detected touch inputs, the detected touch input may be entered at block 106 (Input Entered) to activate the appropriate function or feature.

If the determination at decision block 104 is “no,” the detected touch input may be rejected at block 108 (Input Rejected).

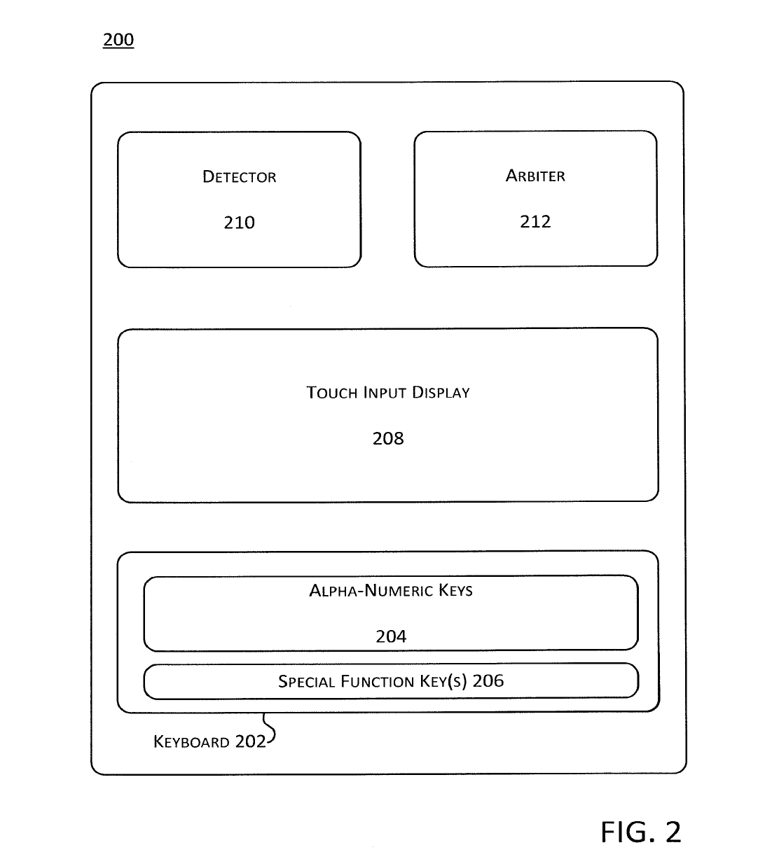

FIG. 2 shows an overview of example touchscreen device 200 upon which at least one embodiment for key input error reduction may be implemented. As depicted, device 200 includes a keyboard 200, a touch display 208, a detector 210, and an arbiter 212.

Device 200 may be a touchscreen input device including, but not limited to, a laptop computer, tablet/slate device, personal digital assistant (PDA), global positioning system (GPS) device, mobile phone, or smart phone.

The components of device 200 described herein, which are not necessarily inclusive of all such components, may be implemented as software, firmware, hardware, or any combination thereof.

Keyboard 202 may be configured as a virtual onscreen keyboard that may be configured to detect the presence and location of a touch input within the context of the onscreen keyboard. Keyboard 202 may include, though not inclusively, alpha-numeric keys 204 and special function keys 206.

Various implementations of device 200 may display keyboard 202 in either a portrait or a landscape configuration, dependent upon the orientation of device 200. Further, English language versions of keyboard 202 may be configured in the well-known QWERTY configuration, though embodiments for key input error reduction are fully applicable to keyboard 202 in any other functional configuration.

Alpha-numeric keys 204 may be configured as virtual onscreen keys that, when touched by a user of device 200, may activate a function or feature, i.e., register an input of a respective alpha-numeric character, for an intended use with an application or program hosted, or running, on device 200. More particularly, the touch input by the user may include a touch by one or more fingers, palm or other suitable body parts of the user, as well as a touch input by a designated passive object such as an input stylus.

Special function keys 206 may be configured as virtual onscreen keys that may include, e.g., a “shift” key, a “control” key, an “alt” key, a “control” key, or a “function” key, though such list is not necessarily exhaustive. Special function keys 206 may further be configured as onscreen keys that, when touched individually, do not register an input to the application or program hosted, or running, on device 200; however, when touched in combination, i.e., simultaneously, with one of alpha-numeric keys 204 or with another special function key or keys, e.g., ctrl-alt-delete, an appropriate function or feature is activated for the application or program. Such touch input for the application or program may include, e.g., an alternative character or modified command dependent upon the application or program, or even an operating system, that is hosted or running on device 200.

Generally, as set forth above, a touch input, i.e., physical contact, for any key, whether one of alpha-numeric keys 204 or special function keys 206, may result in an activation or an enabling of an appropriate function or feature for the application or program hosted, or running, on device 200, unless otherwise specified. Typically, when referring to a singular touch input on keyboard 202, the activated function or feature is an alpha-numeric character, with exceptions including the aforementioned “special functions.”

Touch input display 208 may be configured as an electronic visual display to detect the presence and location of a touch input within the display area. A detected touch input to touch input display 208 may include a touch input by one or more fingers or a palm of the user of device 200, as well as a touch input by a designated passive object such as an input stylus. Further, the touch input may also include a gesture-enhanced single touch, by which multi-finger gestures, e.g., “pinch-to-zoom,” are valid input touches.

Detector 210 may be configured to determine characteristics of a detected touch input to device 200. More particularly, detector 210 may be configured to: determine an appropriate function or feature corresponding to the detected touch input to one or more of alpha-numeric keys 204; determine an appropriate function or feature corresponding to the detected touch input to one or more of special function keys 206 in combination, i.e., simultaneous, with one of alpha-numeric keys 204 or another one of special function keys 206; and determine the appropriate function or feature corresponding to the detected touch input to touch input display 208.

Accordingly, if detector 210 is unable to determine an appropriate function or feature corresponding to the detected touch input to, e.g., a combination of alpha-numeric keys 204 or an combination of more than two special function keys 206, though exceptions may be customized, or if detector 210 determines that a predetermined threshold amount of time has been exceeded since the touch input for which an appropriate function or feature may be determined was detected but for which no end, or termination, has been detected, detector 210 may determine that the detected touch input has characteristics of a key input error.

Arbiter 212 may be configured to reject the detected touch input that has characteristics of a key input error. More particularly, arbiter 212 may determine that, when the detected touch input to either or both of keyboard 202 and touch input display 208 exceeds one or more pre-determined criterion, any function or feature for the application or program hosted, or running, on device 200 corresponding to the input or detected touch is to be rejected.

Accordingly, arbiter 212 may be configured to reject the detected combination of alpha-numeric keys 204 or the combination of more than two special function keys 206 other than the customized exceptions; and arbiter 212 may be further configured to reject the detected touch input, for which an appropriate function or feature or feature may be determined, if an end or termination to the detected touch input has not been detected within the predetermined threshold amount of time.

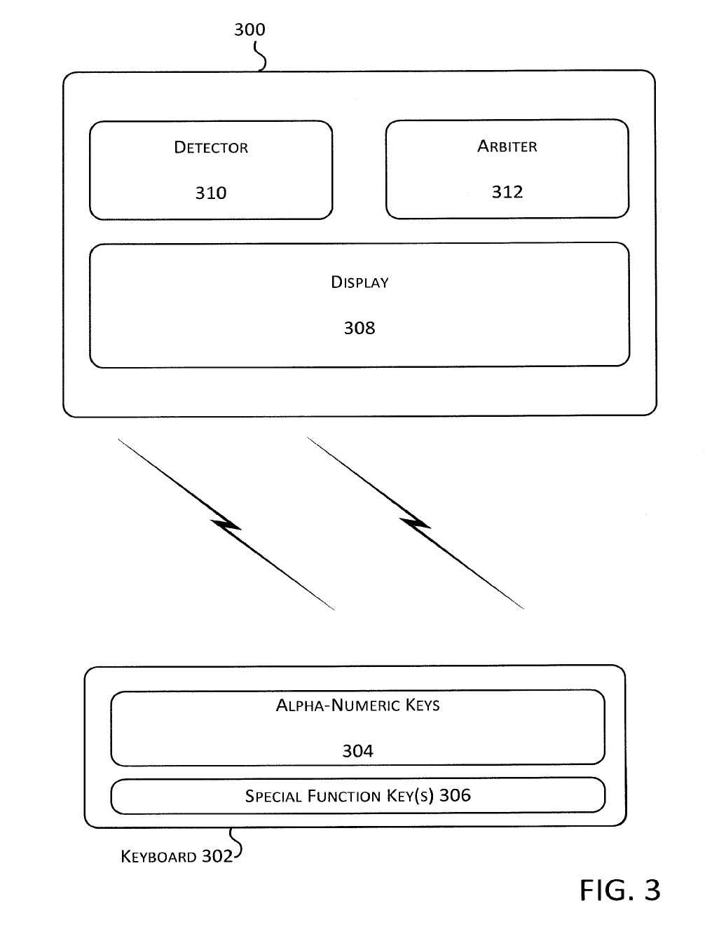

FIG. 3 shows an overview of example touchscreen device 300 upon which at least one embodiment for key input error reduction may be implemented. As depicted, device 300 includes a display 308, a detector 310, and an arbiter 312, and may be coupled to a keyboard 302. Keyboard 302 may be communicatively coupled to processing device 300 via a direct-wired connection or a short-range communications protocol such as, e.g., Bluetooth or Radio Frequency (RF).

Keyboard 302 may be configured as a standard or non-standard keyboard that may be configured to detect a touch input within the context of the keyboard. Keyboard 302 may include, though not inclusively, alpha-numeric keys 304 and special function keys 306.

A standard keyboard may refer to, e.g., a desktop computer keyboard, and a non-standard keyboard may refer to, e.g., a foldable, optical, or projection/laser keyboard.

Keyboard 302 may be configured in the well-known QWERTY configuration, though embodiments for reducing key input errors is fully applicable to keyboard 302 in any other functional configuration.

Alpha-numeric keys 304 may be configured as keys that, when touched by a user of device 300, may activate a function or feature, i.e., register an input of a respective alphabet or numeric character, for an intended use with an application or program hosted, or running, on device 300.

Special function keys 306 may include, e.g., a “shift” key, a “control” key, an “alt” key, a “control” key, or a “function” key, though such list is not necessarily exhaustive. Special function keys may be configured as keys that, when touched individually, do not register an input to the application or program hosted, or running, on device 300; however, when touched in combination, i.e., simultaneously, with one of alpha-numeric keys 304, an appropriate function or feature is activated for the application or program. Such touch input for the application or program may include, e.g., an alternative character or modified command dependent upon the application or program, or even an operating system, that is hosted or running on device 300.

Generally, as set forth above, a touch input, i.e., physical contact for any key, whether one of alpha-numeric keys 304 or special function keys 306, may result in an activation or an enabling of an appropriate function or feature for the application or program hosted, or running, on device 300, unless otherwise specified. Typically, when referring to a singular touch input on keyboard 302, the activated function or feature is an alpha-numeric character, with exceptions including the aforementioned “special functions.”

Device 300 may be a processing device including, but not limited to, a desktop computer or laptop computer.

The components of device 300 described herein, which are not necessarily inclusive of all such components, may be implemented as software, firmware, a combination of both, or hardware.

Display 308 may be configured as an electronic visual display, which may or may not be a touch device to detect the presence and location of a touch input within the display area. Further, display 308 may be incorporated within device 300, as shown, or may be implemented separately as hardware, software, or firmware that is communicatively coupled to device 300 via a direct-wired connection or a short-range communications protocol such as, e.g., Bluetooth or RF.

Detector 310 may be configured to determine characteristics of a detected touch input to device 300. More particularly, detector 310 may be configured to: determine an appropriate function or feature corresponding to the detected touch input to one or more of alpha-numeric keys 304; determine an appropriate function or feature corresponding to the detected touch input to one or more of special function keys 306 in combination, i.e., simultaneous, with one of alpha-numeric keys 304 or another one of special function keys 306; and determine the appropriate function or feature corresponding to the detected touch input to touch input display 308 if display 308 is configured as a touch device.

Accordingly, if detector 310 is unable to determine an appropriate function or feature corresponding to the detected touch input to, e.g., a combination of alpha-numeric keys 304 or an combination of more than two special function keys 306, though exceptions may be customized; or if detector 310 determines that a predetermined threshold amount of time has been exceeded since the touch input for which an appropriate function or feature may be determined was detected but for which no end, or termination, has been detected, detector 310 may determine that the detected touch input has characteristics of a key input error.

Arbiter 312 may be configured to reject the detected touch input that has characteristics of a key input error. More particularly, arbiter 312 may determine that, when the detected touch input to either or both of keyboard 302 and touch input display 308 exceeds one or more pre-determined criterion, any function or feature for the application or program hosted, or running, on device 300 corresponding to the input or detected touch is to be rejected.

Accordingly, arbiter 312 may be configured to reject the detected combination of alpha-numeric keys 304 or the combination of more than two special function keys 306 other than the customized exceptions; and arbiter 312 may be further configured to reject the detected touch input, for which an appropriate function or feature or feature may be determined, if an end or termination to the detected touch input has not been detected within the predetermined threshold amount of time.

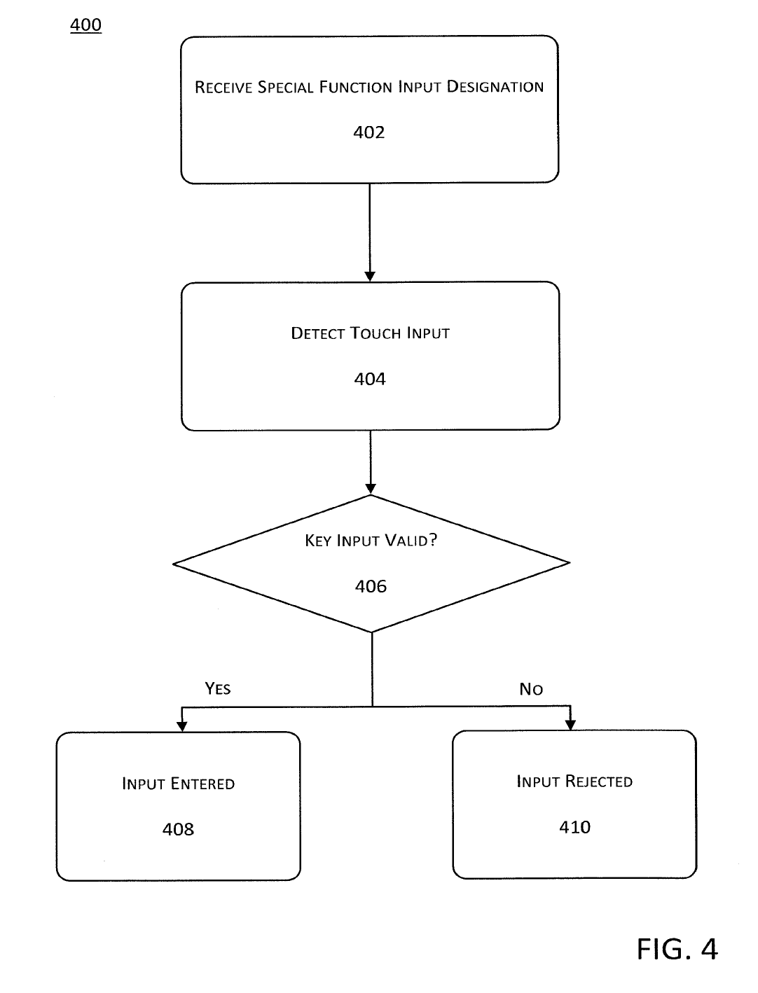

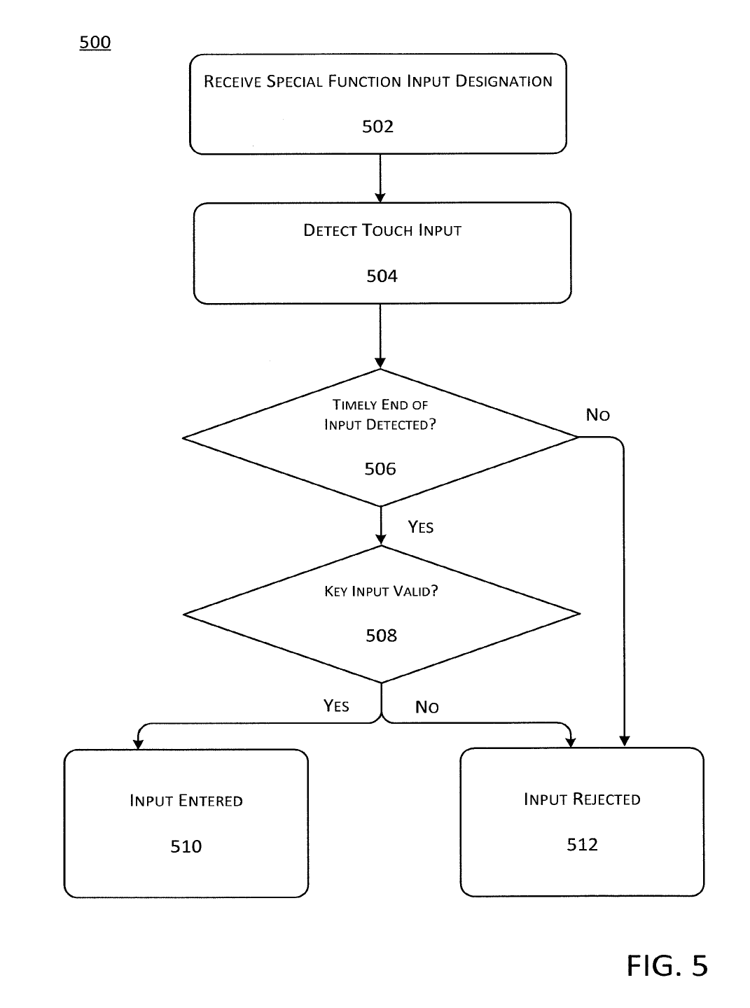

Regarding the processing flows described herein with reference to FIG. 4 and FIG. 5, the blocks in FIGS. 4 and 5 may be operations that can be implemented in software, firmware, hardware, or a combination thereof. In the context of software, the blocks represent computer-executable instructions that, when executed by one or more processors, cause one or more processors to perform the recited operations. Generally, computer-executable instructions include routines, programs, objects, components, data structures, and the like that cause the particular functions to be performed or particular abstract data types to be implemented.

FIG. 4 shows an example processing flow 400 for key input error reduction. The description of processing flow 400 may refer to, at least, either of the embodiments of FIG. 2 and FIG. 3, unless otherwise noted. Therefore, the references to the features having similar functionality in the embodiments of FIG. 2 and FIG. 3 are referenced in combination. An example processing flow may include one or more operations, actions, or functions as illustrated by one or more of blocks 402, 404, 406, 408 and/or 410. Although illustrated as discrete blocks, various blocks may be divided into additional blocks, combined into fewer blocks, or eliminated, depending on the desired implementation. Processing may begin at block 402.

Block 402 (Receive Special Function Input Designation) may include the designation of a valid combination, i.e., simultaneous, of touch inputs to keyboard 202/302; or, alternatively, a valid combination, i.e., simultaneous, of touch inputs to keyboard 202/302 and touch input display 208/308, if display 208/308 is configured as a touch device. In particular, the special function input designation may pertain to valid combinations of touch inputs, including a valid combination of one or more of special function keys 206/306 and one or more of alpha-numeric keys 204/304; or, alternatively, a valid combination of one or more of special function keys 206/306 and one or more touch inputs to touch input display 208/308, if display 208/308 is configured as a touch device. Further, the special function input designation is likely to be made during the coding of the software or firmware upon which data input features for device 200/300 is implemented; however, such software or firmware may also facilitate the customization of valid touch input combinations as part of re-programming the applications or programs hosted on the device 200/300. Processing may continue from block 402 to block 404.

Block 404 (Detect Touch Input) may include detector 210/310 detecting a touch input of any combination of, i.e., simultaneous, of touch inputs from keyboard 202/302; or, alternatively, touch inputs from keyboard 202/302 and touch input display 208/308 if display 208/308 is configured as a touch device. Processing may continue from block 404 to decision block 406.

Decision block 406 (Key Input Valid?) may include detector 210/310 determining whether there is an appropriate function or feature corresponding to the detected touch input to one or more of alpha-numeric keys 204/304; determining whether there is an appropriate function or feature corresponding to the detected touch input to one or more of special function keys 206/306 in combination, i.e., simultaneous, with one of alpha-numeric keys 204/304 or another one of special function keys 206/306; and determining whether there is an appropriate function or feature corresponding to the detected touch input to touch input display 208/308 if display 208/308 is configured as a touch device. Processing may continue from decision block 406 to either block 408 or 410.

If the determination at decision block 406 is “yes,” block 408 (Input Entered) may include arbiter 212/312 entering the touch input detected at block 404 by activating the appropriate function or feature corresponding to the detected touch input.

If the determination at decision block 406 is “no,” block 410 (Input Rejected) may include arbiter 212/312 rejecting the touch input detected at block 404.

Thus, erroneous touch inputs to keyboard 202/302 or, alternatively, keyboard 202/302 and touch input display 208/308, due to inadvertent multiple touch inputs may be significantly reduced.

Further, in the same manner described above, processing flow 400 may be applied to virtual onscreen keyboards on which touch input is accomplished by tracing a path over keys. Thus, the error-correcting techniques therefore may follow processing flow 400.

FIG. 5 shows another example processing flow 500 for key input error reduction. The description of processing flow 500 may refer to either of the embodiments of FIG. 2 and FIG. 3. Therefore, the references to the features having similar functionality in the embodiments of FIG. 2 and FIG. 3 will be referred to in combination. An example processing flow may include one or more operations, actions, or functions as illustrated by one or more of blocks 502, 504, 506, 508, 510 and/or 512. Although illustrated as discrete blocks, various blocks may be divided into additional blocks, combined into fewer blocks, or eliminated, depending on the desired implementation. Processing may begin at block 502.

Block 502 (Receive Special Function Input Designation) may include the designation of one or more valid touch inputs to keyboard 202/302; or, alternatively, keyboard 202/302 and touch input display 208/308 if display 208/308 is configured as a touch device. In particular, the designation may pertain to valid touch inputs, including valid combinations of one or more of special function keys 206/306 and one or more of alpha-numeric keys 204/304; or, alternatively, valid combinations of one or more of special function keys 206/306 and one or more touch inputs to touch input display 208/308 if display 208/308 is configured as a touch device. Further, the designation is likely to be made during the coding of the software or firmware upon which data input features for device 200/300 is implemented; however, such software or firmware may also facilitate the customization of valid touch input combinations as part of re-programming the applications or programs hosted on the device 200/300. Processing may continue from block 502 to block 504.

Block 504 (Detect Touch Input) may include detector 210/310 detecting a touch input of any combination of, i.e., simultaneous, of touch inputs from keyboard 202/302; or, alternatively, touch inputs from keyboard 202/302 and touch input display 208/308 if display 208/308 is configured as a touch device. Processing may continue from block 504 to decision block 506.

Decision block 506 (Timely End of Input Detected?) may include detector 210/310 further determining whether an end or termination to the touch input has been detected before a predetermined threshold amount of time has elapsed. Processing may continue from decision block 506 to either decision block 508 or block 512.

If the determination at decision block 506 is “no,” block 512 (Input Rejected) may include arbiter 212/312 rejecting the touch input detected at block 504.

If the determination at decision block 506 is “yes,” decision block 508 (Key Input Valid?) may include detector 210/310 further determining whether there is an appropriate function or feature corresponding to the detected touch input to one or more of alpha-numeric keys 204/304; determining whether there is an appropriate function or feature corresponding to a detected touch input to one or more of special function keys 206/306 in combination, i.e., simultaneous, with one of alpha-numeric keys 204/304 or another one of special function keys 206/306; and determining whether there is an appropriate function or feature corresponding to the detected touch input to touch input display 208/308 if display 208/308 is configured as a touch device. Processing may continue from decision block 508 to either block 510 or 512.

If the determination at decision block 508 is “yes,” block 510 (Input Entered) may include arbiter 212/312 entering the touch input detected at block 504 by activating the appropriate function or feature corresponding to the detected touch input.

If the determination at decision block 508 is “no,” block 512 (Input Rejected) may include arbiter 212/312 rejecting the touch input detected at block 504.

Thus, erroneous input to keyboard 202/302 or, in the alternative, keyboard 202 and touch input display 208, due to inadvertent or otherwise erroneous, extended inputs, as well as inadvertent multiple touch inputs may be significantly reduced.

Further, in the same manner described above, processing flow 500 may be applied to virtual onscreen keyboards on which touch input is accomplished by tracing a path over keys. Thus, the error-correcting algorithms therefore may follow processing flow 400.

The present disclosure is not to be limited in terms of the particular embodiments described in this application, which are intended as illustrations of various aspects. Many modifications and variations can be made without departing from its spirit and scope, as will be apparent to those skilled in the art. Functionally equivalent processes and even apparatuses within the scope of the disclosure, in addition to those described herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that the terminology used herein is for the purpose of describing particular embodiments only, and is not intended to be limiting.

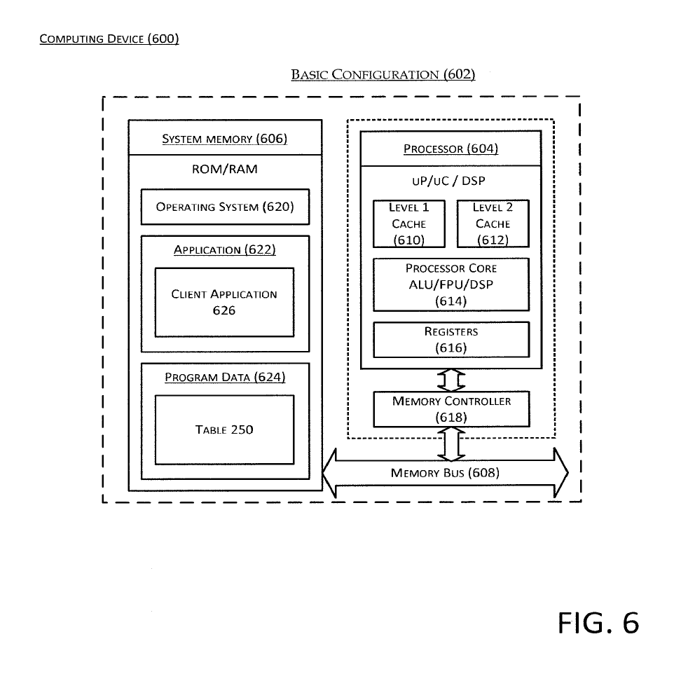

FIG. 6 shows a block diagram illustrating an example computing device 600 by which various embodiments of the example solutions for key input error reduction described herein may be implemented.

More particularly, FIG. 6 shows an illustrative computing embodiment, in which any of the processes and sub-processes described herein may be implemented as computer-readable instructions stored on a computer-readable medium. The computer-readable instructions may, for example, be executed by a processor of a mobile unit, a network element, and/or any other computing device, particularly as applicable to the applications and/or programs described above corresponding to device 200.

In a very basic configuration 602, a computing device 600 may typically include one or more processors 604 and a system memory 606. A memory bus 608 may be used for communicating between processor 604 and system memory 606.

Depending on the desired configuration, processor 604 may be of any type including but not limited to a microprocessor (μP), a microcontroller (μC), a digital signal processor (DSP), or any combination thereof.

Depending on the desired configuration, system memory 606 may be of any type including but not limited to volatile memory (such as RAM), non-volatile memory (such as ROM, flash memory, etc.) or any combination thereof. System memory 606 may include an operating system 620, one or more applications 622, and program data 624.

Application 622 may include the aforementioned applications or programs that are arranged to perform the functions ascribed to devices 200 and 300, which are described previously with respect to FIGS. 1-5. Program data 624 may include table 250, which may be useful for implementing key input error reduction as described herein.

System memory 606 is an example of computer storage media. Computer storage media may include, but not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which may be used to store the desired information and which may be accessed by computing device 600. Any such computer storage media may be part of computing device 600.

The network communication link may be one example of a communication media. Communication media may typically be embodied by computer readable instructions, data structures, program modules, or other data in a modulated data signal, such as a carrier wave or other transport mechanism, and may include any information delivery media. A “modulated data signal” may be a signal that has one or more of its characteristics set or changed in such a manner as to encode information in the signal. By way of example, and not limitation, communication media may include wired media such as a wired network or direct-wired connection, and wireless media such as acoustic, radio frequency (RF), microwave, infrared (IR) and other wireless media. The term computer readable media as used herein may include both storage media and communication media.

Computing device 600 may be implemented as a portion of a small-form factor portable (or mobile) electronic device such as a cell phone, a personal data assistant (PDA), a personal media player device, a wireless web-watch device, a personal headset device, an application specific device, or a hybrid device that include any of the above functions. Computing device 600 may also be implemented as a personal computer including both laptop computer and non-laptop computer configurations.

There is little distinction left between hardware and software implementations of aspects of systems; the use of hardware or software is generally (but not always, in that in certain contexts the choice between hardware and software can become significant) a design choice representing cost vs. efficiency tradeoffs. There are various vehicles by which processes and/or systems and/or other technologies described herein may be implemented, e.g., hardware, software, and/or firmware, and that the preferred vehicle may vary with the context in which the processes and/or systems and/or other technologies are deployed. For example, if an implementer determines that speed and accuracy are paramount, the implementer may opt for a mainly hardware and/or firmware vehicle; if flexibility is paramount, the implementer may opt for a mainly software implementation; or, yet again alternatively, the implementer may opt for some combination of hardware, software, and/or firmware.

The foregoing detailed description has set forth various embodiments of the devices and/or processes for key input error reduction 400 and 500 via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers, e.g., as one or more programs running on one or more computer systems, as one or more programs running on one or more processors, e.g., as one or more programs running on one or more microprocessors, as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors, e.g., feedback for sensing position and/or velocity; control motors for moving and/or adjusting components and/or quantities. A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely examples and that, in fact, many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

1. A device, comprising:
a detector to determine characteristics of a detected touch input; and
an arbiter to reject the detected touch input that has characteristics of a key input error.

2. The device of claim 1, wherein the characteristics of a key input error include a simultaneous multi-touch input that does not include a touch input of a special function key.

3. The device of claim 1, wherein the characteristics of a key input error include a simultaneous multi-touch input that does not include a touch input of at least one of a “shift” key, a “control” key, an “alt” key, or a “function” key.

4. The device of claim 1, wherein the characteristics of a key input error include a continuous key input for a duration that exceeds a predetermined threshold limit.

5. The device of claim 1, wherein the characteristics of a key input error includes a continuous key input of a non-special function key for a duration that exceeds a predetermined threshold limit.

6. A computer-readable medium that stores one or more executable instructions that, when executed, cause one or more processors to:
receive a designation of a special function input;
determine whether a simultaneous multi-touch input includes the special function input; and
deny entry of a function or feature corresponding to the simultaneous multi-touch input when the determination is negative.

7. The computer-readable medium of claim 6, wherein the computer-readable medium and the one or more processors are hosted on a client device that is communicatively coupled to a standard keyboard of which the special function input is a key.

8. The computer-readable medium of claim 6, wherein the computer-readable medium and the one or more processors are hosted on a client device that includes a touch keyboard of which the special function input is a key.

9. The computer-readable medium of claim 6,
wherein the computer-readable medium and the one or more processors are hosted on a client device that includes a virtual keyboard, and
wherein further the multi-touch input includes a simultaneous input from two or more keys on the virtual keyboard.

10. The computer-readable medium of claim 8, wherein the special function input includes at least one of a “shift” key, a “control” key, an “alt” key, or a “function” key.

11. The computer-readable medium of claim 8, wherein the special function input includes a user-designated combination of keys.

12. The computer-readable medium of claim 6, wherein the computer-readable medium and the one or more processors are hosted on a client device that includes:
a virtual keyboard of which the special function input is a key, and
a touch input display.

13. The computer-readable medium of claim 6,
wherein the computer-readable medium and the one or more processors are hosted on a client device that includes a virtual keyboard and a touch input display, and
wherein further the multi-touch input includes an input from either of the virtual keyboard and the touch input display simultaneous with at least one other input from either of the virtual keyboard and the touch input display.

14. The computer-readable medium of claim 13, wherein the special function input includes at least one of a “shift” key, a “control” key, an “alt” key, or a “function” key.

15. The computer-readable medium of claim 13, wherein the special function input includes a user-designated combination of touch inputs.

16. A device, comprising:
a key input user interface to receive a key input from a user;
a detector to measure time from a detected start of the key input from the user;
an arbiter to reject a function corresponding to the key input from the user when an end of the key input has not been detected within a predetermined threshold amount of time.

17. The device of claim 16,
wherein the key input user interface is a virtual keyboard, and
wherein further the key input corresponds to physical contact with any key on the virtual keyboard that is not designated as a special function key.

18. The device of claim 16,
wherein the key input user interface is a standard keyboard, and
wherein further the key input corresponds to physical contact with any key on the standard keyboard that is not designated as a special function key.

19. The device of claim 17, wherein the special function key may be at least one of the “shift” key, the “control” key, the “alt” key, or the “function” key.

20. A computer-readable medium that stores one or more executable instructions that, when executed, cause one or more processors to:
detect a touch input;
time the touch input; and
reject the touch input after a predetermined amount of time has elapsed and an end to the touch input has not been detected.

21. The computer-readable medium of claim 20, wherein the special function key may be at least one of the “shift” key, the “control” key, the “alt” key, or the “function” key.
